(19) United States
(12) Patent Application Publication
(10) Pub. No.: US 2024/0051053 A1
(43) Pub. Date: Feb. 15, 2024

(54) METHOD FOR BUILD-UP WELDING OF MATERIAL IN THE FORM OF POWDER OR WIRE ONTO A WORKPIECE

(71) Applicant: Technische Universität Wien, Wien (AT)

(72) Inventors: Paul HAYDEN, Wien (AT); Johann LAIMER, Baden (AT)

(21) Appl. No.: 17/754,551

(22) PCT Filed: Sep. 30, 2020
(86) PCT No.: PCT/AT2020/060348

§ 371 Date: Apr. 5, 2022

(30) Foreign Application Priority Data
Oct. 7, 2019 (AT) A 50851/2019

(51) Int. Cl. B23K 9/04; B23K 9/173; B23K 9/29

(52) U.S. Cl. CPC B23K 9/042; B23K 9/173; B23K 9/295

(57) ABSTRACT

A method of build-up welding a powdery or wire-shaped material onto a workpiece, which is preferably a flat substrate, by means of a device which comprises a substantially rod-shaped electrode, the electrode having at least one material feed channel extending in its interior, the device comprising a nozzle surrounding the electrode, the method comprising the following steps:
forming the arc as a transferred arc between the electrode and the workpiece or as a free-standing arc between the electrode and the nozzle,
flooding the working gas area with a working gas to constrict the arc in the direction of the workpiece,
feeding the powdery or wire-shaped material into the constricted arc and
moving the device across the workpiece as the powdery or wire-shaped material is being fed into the constricted arc.

The present invention relates to a method of build-up welding (deposition welding) a powdery or wire-shaped material onto a workpiece, which is preferably a flat substrate, by means of a device which comprises an essentially rod-shaped electrode, the electrode having at least one material feed channel extending in its interior for feeding the powdery or wire-shaped material into the arc.

In the field of build-up welding, the method of arc welding for applying material onto a surface to be machined has been known for quite some time. Arc welding is a process that involves the localized liquefaction of metals. In doing so, an arc is ignited between the workpiece and a current-carrying electrode and is maintained by the current flowing through the electrode, arc and workpiece. Since the properties of the arc and the molten metal depend on the atmosphere, specialized gases, mostly argon, but also, for example, CO₂, are blown around the molten metal to introduce carbon in a controlled manner so as to avoid oxidation, so that welding can take place in a controlled atmosphere.

Build-up welding provides the arc with fresh material which is liquefied and applied to the surface to be welded. Said material is usually introduced laterally into the arc as a metal wire or a powder. A special form of build-up welding is the MIG/MAG process in which material is fed in as a wire electrode and is melted in the arc and thus applied. In this case, the current-carrying wire forms the electrode so that the arc is formed between the wire and the workpiece.

The cold metal transfer (CMT) process from Fronius is well known in the field of precision build-up welding. It is a modification of the MIG/MAG process that supplies a welding wire as a current-carrying electrode to the welding region, where it melts due to the heat of an arc between the welding wire and the welding region. In the CMT process, this wire is not fed in constantly, but is fed in and withdrawn depending on the current flow, whereby drops of the liquefied material can be deposited precisely in the welding region.

Tungsten inert gas (TIG) welding is furthermore known, which is a commonly chosen process in which a current-carrying tungsten electrode is sharpened to a point and argon is continuously flushed around the electrode. In this process, a wire is introduced laterally into the arc.

A modification of arc welding is plasma welding. In doing so, the arc is forced through a nozzle so as to better control its geometric and thermal properties. The electrode is in an axially centered position behind the nozzle. Frequently, the nozzle, which is often made of copper, is itself conductive in order to be able to ignite a primary arc between the electrode and the nozzle. Once the primary arc has reached the workpiece, the current flow to the nozzle can be cut off and the arc between the electrode and the workpiece can be operated instead.

Plasma build-up welding, like arc build-up welding, can be accomplished by feeding in material laterally, but since plasma build-up welding allows much higher temperatures than arc build-up welding, other types of material liquefaction are possible as well.

In one of those types of liquefaction, plasma spraying, a primary arc between the electrode and the nozzle is kept as extensive as possible thanks to favourable system parameters. This can be achieved by a longer nozzle and by operating in low-pressure chambers. A powder is introduced into the long plasma flame, the powder being transported and accelerated with the hot gas. The powder exits the plasma flame in a molten state and at a high speed and impinges on a surface to be treated. There, the liquid droplets solidify instantly. Since the droplets are indeed very hot, but their inherent heat capacity is minor, the thermal power deposited on the workpiece is low. In this case, the quality of the sprayed surface is largely determined by the time spent by the powder in the plasma flame. Therefore, the length of the plasma flame is one of the parameters to be maximized.

Document US 2012193329 A1 discloses a powder microsparks deposition system comprising an electrode and a powder feed channel configured within or at least partially around the electrode so as to guide a powder, which comprises an electrically conductive material, into a gap between the electrode and the substrate.

In addition, document EP 264243 A2 discloses a method which uses the powder microsparks system from US 2012193329 A1 for repairing a metallic object.

Document US 2014008330 A1 also shows a method of repairing a component, in which an electrode is positioned above a defect or damage. In doing so, a first metal powder and a second metal powder can be fed into a discharge gap between the electrode and the component to form a hybrid metal coating.

Document DE 3110628 A1 discloses a method of producing alloyed surfaces on pipes, wherein an alloy material is introduced into an arc through an electrode of a hollow design.

It is indeed known that the surface quality increases in principle as a result of the axial powder supply, in practice, however, these methods exhibit material accumulations on the nozzle surrounding the electrode, which, as a result, gets increasingly clogged due to the material accumulations. On the one hand, if contact is made between the nozzle and the electrode due to accumulated material, the device for build-up welding can then become permanently unusable and must be replaced, involving high costs. On the other hand, even if there has been no contact with the electrode and the nozzle due to accumulated material for an extended period of time, not only is the improvement in surface quality de facto prevented by the clogging, but the device for build-up welding must, in addition, even be freed from the material applied to the nozzle, which entails complex and time-consuming maintenance work. Furthermore, the breakdown of the welding device during the production results in high costs because of the production shutdown. In addition, due to the clogging of the nozzle, these methods show reduced precision when applying the material to the surface to be machined, since the material accumulated at the nozzle hampers the flushing of a working gas around the electrode.

The object of the invention is therefore to provide a method that avoids the disadvantages of the prior art and opens up new manufacturing methods through the precision gained. Said object is achieved by providing a method for build-up welding of powdery or wire-shaped material having the features of claim 1.

In the method according to the invention, the device comprises a nozzle surrounding the electrode and a working gas area which is formed between the electrode and the nozzle, the method comprising the following steps:
forming the arc as a transferred arc between the electrode and the workpiece or as a free-standing arc between the electrode and the nozzle,
flooding the working gas area with a working gas to constrict the arc in the direction of the workpiece,
feeding the powdery or wire-shaped material into the constricted arc and
moving the device across the workpiece as the powdery or wire-shaped material is being fed into the constricted arc.

As a result, it is achieved that, by preventing the arc from migrating, it is ensured that the arc is guided straightly and, subsequently, the material in its powdery or wire-shaped state is fed precisely into the arc, material is melted in the arc and the molten material is fed precisely onto the workpiece. Furthermore, by using a short nozzle and precise control of the arc by constriction, material is effectively prevented from accumulating in the nozzle, whereby the durability of the device is increased. Furthermore, the shape of the arc can be adjusted by selecting the flow rate of the working gas. As a result, the arc power and the flow rate of the gas can be dynamically adjusted in order to optimize the precision and speed of the method.

The working gas area, in which the working gas flows around the electrode and the arc, can thus advantageously be formed around the electrode in order to control the gas composition around the working area, which in turn affects the arc power. Furthermore, chemical reactions can take place between the atmosphere and the liquid metal. This can be prevented by flushing with working gases such as argon or helium, or by using suitable active gases such as, for example, CO₂ for optimizing the material. During the steps of forming the arc and flooding the working gas area, it is irrelevant which of the two steps is started first.

According to a further preferred embodiment, a radial distance between the nozzle and the electrode is not larger than 1 cm and/or an axial distance between the end of the nozzle facing the workpiece and the end of the electrode facing the workpiece is not larger than 1 cm, with the end of the nozzle facing the workpiece preferably having a smaller distance from the workpiece than the end of the electrode facing the workpiece. Advantageously, the arc between the electrode and the nozzle can thus be formed in a particularly simple manner, especially by selecting a preferred distance between the electrode and the nozzle. Furthermore, this embodiment of the nozzle allows working gas to be supplied at the arc base of the electrode and, with an appropriate flow rate, the arc to be constricted in the direction of the workpiece. In this case, the range of a suitable flow rate depends on the geometry of the nozzle, the electrode and the workpiece as well as on the arc power and can thus be adjusted dynamically for achieving the highest possible precision. The nozzles known from the prior art for other welding processes usually have a length that is longer than 10 cm in order to form a particularly long arc, which, however, is not necessary for the build-up welding method according to the invention.

Between the nozzle and an atmosphere protection casing surrounding the nozzle, a further working gas area is preferably formed which is flooded with another working gas before build-up welding is started so that a controlled atmosphere is generated at an application point of the workpiece. Advantageously, the atmosphere at the point of application of the workpiece to be machined can thus be controlled in an optimum fashion. The gas composition influences the arc power and must therefore be controlled. Furthermore, chemical reactions can take place between the atmosphere and the liquid metal. This can be prevented by flushing with working gases such as argon or helium, or by using suitable active gases such as, for example, CO2 for optimizing the material.

Alternatively, the device is used in a chamber with a controlled atmosphere. Then, no gas has to be supplied by the first gas stream. A chamber with a controlled atmosphere avoids turbulences, which might occur around the electrode as a result of gas being flushed, and thus permits particularly precise working. Furthermore, a chamber with a controlled atmosphere permits a greater distance between the electrode and the workpiece without losses in precision due to turbulences, whereby longer arcs are rendered possible. However, since a longer distance in itself lowers the precision, this implementation is particularly suitable for surface finishing.

The method is preferably used for joint welding, wherein the powdery or wire-shaped material for this purpose is preferably a metal, or the method is used for surface finishing, wherein the powdery or wire-shaped material for this purpose is preferably a ceramic powder, a metal or a carbide powder. Powdery material is particularly preferably used for surface finishing. The method according to the invention can thus be used for two different areas of application, on the one hand, for joint welding and, on the other hand, for surface finishing. The same device can be used for both intended applications, wherein a different respective material, material feed rate and/or arc power can be chosen in each case.

According to a further preferred embodiment, the powdery or wire-shaped material is supplied in an additional working gas, which is preferably argon, helium, carbon dioxide or nitrogen, wherein also the working gas and/or the further working gas is/are preferably argon, helium, carbon dioxide or nitrogen. If identical working gases are used, the advantage arises that the atmosphere on the material also remains homogeneous. Different gases trigger chemical reactions, which, however, may also be advantageous for the molten metal. The working gas supplied through the nozzle can thus be identical to that of the controlled atmosphere around the arc, or else it can be different therefrom in order to specifically achieve chemical reactions in the arc. For example, H₂ in the arc can react with a CO₂ atmosphere in order to add carbon to the liquid metal.

The distance between the electrode and the workpiece and/or a position of the electrode on the workpiece is preferably controlled by a mechanical guide. On the one hand, structures can be applied to the workpiece by the guide, and, on the other hand, the distance from the workpiece can be adjusted at any time, for example, in order to account for irregularities in the workpiece or an inclination of the workpiece, which would not be possible with a manual guide of the device. Furthermore, surfaces of workpieces can be functionalized by the guide, for example, in order to create abrasion-resistant or high-melting surfaces of materials. In particular, the guide also allows materials that are not themselves powered for the welding process to be machined with the method according to the invention. Workpieces other than, for example, pipes on a turning lathe can therefore also be machined by means of the method according to the invention. The guide is preferably a CNC guide or a robotic arm.

According to a further preferred embodiment, the powdery or wire-shaped material is applied to the workpiece in layers in order to form layers of material overlying each other. For example, the method may therefore comprise the first step of build-up welding at a first spot of the workpiece and the second step of another build-up welding at the same spot of the workpiece. This has the effect that complex, multi-layered structures and shapes can be applied to the workpiece. In doing so, shaping can be done by repeatedly multipass milling the volume and adding material, which is an additive process for creating a working piece. In particular, mechanical shaping after the application is not necessary for producing a desired shape.

With the above-mentioned embodiment, on the one hand, a working piece can thus be produced, which can be detached from the substrate and used independently, for example, a screw-on joint. On the other hand, the working piece can remain on the workpiece in order to fulfill a function there, for example, as a joint socket which is applied to a metal profile.

According to a further preferred embodiment, the nozzle has internal channels for receiving cooling fluid, and the electrode has cooling means on its holder. Thus, the advantage is obtained that the cooling of the device, on the one hand, increases the service life of the device and, on the other hand, avoids damage to the device caused by overheating as well as a resulting costly interruption of the work process.

Preferably, the opening diameter of the electrode is 1 cm at most, particularly preferably essentially 300 μm at most. Furthermore, the electrode can preferably be tapered at its end facing the workpiece. As a result, an arc can be ignited with greater ease.

According to a further preferred embodiment, the arc power and the mixing ratios and/or the flow speeds of the gases as mentioned are adjusted in order to adjust the precision and the speed of the application of the powdery or wire-shaped material to the workpiece.

In a particularly preferred embodiment, the powdery or wire-shaped material is melted off in said arc. The arc preferably extends directly between the electrode and the workpiece into the powdered or wire-shaped material without flashover, which can be achieved by setting a suitable arc power and a suitable feed of the powdery or wire-shaped material. Such parameters can be chosen by a person skilled in the art, wherein usually the arc power is chosen to be high and the feed is chosen to be low. Alternatively, the arc can flash over briefly into the material, i.e., a first flashover arises between the electrode and the material and a second flashover arises between the material and the workpiece, with the melting of the material usually occurring in the second flashover. In order to achieve this variant, a person skilled in the art can again choose the arc power and the feed, wherein the arc power is chosen to be low and the feed is chosen to be high in comparison to the previous variant. However, it should be noted that the latter variant should not be confused with MIG welding in which there is a current flow through an electrode without an arc into the wire and the arc only runs between the wire and the workpiece.

In a further preferred embodiment, the electrode ends in the feed direction of the powdery or wire-shaped material in front of the material feed channel or at the same point as the material feed channel. The former alternative is achieved, for example, by an electrode which has a bore with an inner coating and is tapered at its end. As a result, the material feed channel is lengthened in relation to the electrode toward the feed direction of the material, which facilitates the flashover of the arc from the electrode directly to the workpiece or, respectively, the nozzle. The second alternative mentioned can be achieved, for example, by the electrode having a bore without an inner coating. Regardless of whether the cathode is tapered at its end or not, the electrode will end in the feed direction of the material at the same point as the material feed channel.

A particularly advantageous application of said method of build-up welding results when the workpiece is arranged above the device during build-up welding. When it is used in this way, the molten material can be moved toward the workpiece against the force of gravity by the constricted arc without the molten material dripping down.

Advantageous and non-limiting embodiments of the invention are explained in further detail below with reference to the drawings.

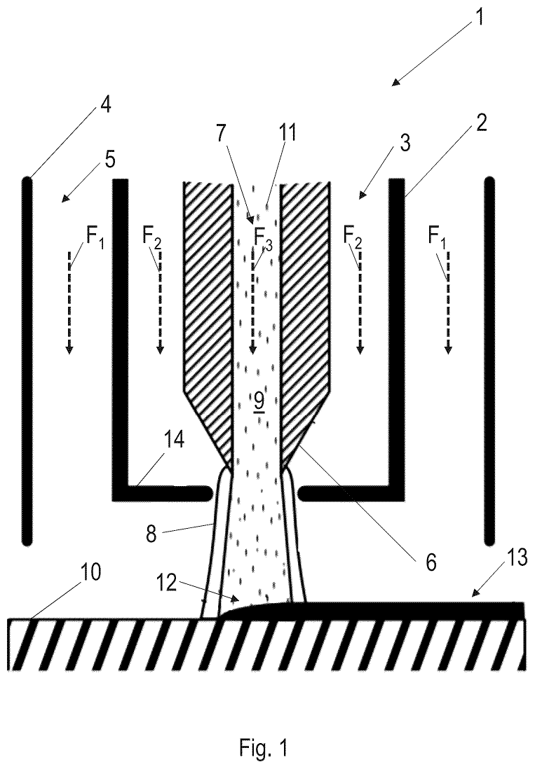

FIG. 1 shows an embodiment of the method according to the invention in a schematic cross-sectional view.

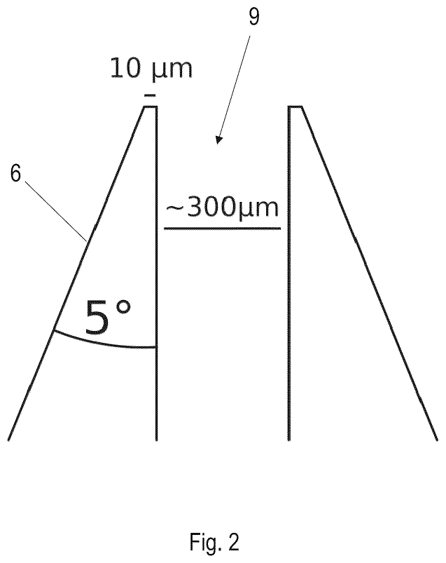

FIG. 2 schematically shows an enlargement of the electrode illustrated in FIG. 1 in a cross-sectional view.

FIG. 1 shows a device 1 for build-up welding a powdery or wire-shaped material 11 onto a workpiece 10. The device 1 comprises a substantially rod-shaped electrode 6, which, for example, is accommodated in a holder, the electrode 6 having at least one material feed channel 9 extending in its interior for feeding the powdery or wire-shaped material 11 into an arc 8. The workpiece 10 is preferably a flat substrate rather than, in particular, a tube, since the curvature thereof would impair the precision of the method.

The method of build-up welding is explained in further detail below. Up to three different working gases 3, 5, 7 or, respectively, corresponding working gas flows can be used in the method, with a first working gas being referred to as “a working gas 3”, a second working gas being referred to as “a further working gas 5” and a third working gas being referred to as “an additional working gas 7”. The working gases 3, 5, 7 can have different or identical compositions, as explained in further detail below. In particular, all working gases 3, 5, 7 can be protective gases or active gases.

For implementing the method, as illustrated in FIG. 1, an electrode 6 made of a material resistant to high temperatures, for example, made of tungsten, preferably for using an inert gas, or, for example, made of hafnium, preferably for using an active gas, is used. This electrode 6 has the outlet of a channel 9 at a location where the arc 10 begins, wherein the channel 9 can be supplied with a flow of an additional working gas 7, which is mixed with a powdery or wire-shaped material 11, at its end facing away from the workpiece 10.

For example, in case of a hafnium electrode, which exists in the form of a disk pressed into a soft metal, said channel 9 can be provided as a central bore through the hafnium insert. On the other hand, in case of a tungsten electrode, the electrode 6 is usually subjected to sharpening. In order to sharpen a cylindrical electrode in an axial manner, the electrode 6 can be clamped into a turning lathe and ground to the desired acute angle with a clamped grinding machine. With tungsten electrodes, a sharpening angle of 10° has proved to be sufficiently acute, as can also be seen from FIG. 2. For sharpening, a margin of approx. 10 μm may remain between the channel and the outer diameter in order to allow for tolerances during the clamping process.

Electrodes 6 can also be manufactured already with the channel 9, for example, during sintering with an axial obstacle in the cavity. Tungsten electrodes that have already been manufactured can also be machined using the electrode erosion process in order to construct the axial channel 9 axially through the electrode 6. A drift of the die-sinking wire cannot be avoided during electrode erosion, which leads to a curved channel 9. In practice, however, this bend has not proven to be a hindrance for electrodes shorter than 6 cm.

As already mentioned above, the channel 9 is supplied with a powdery or wire-shaped material 11 at its end facing away from the surface to be machined. For example, in order to supply the material 11, the additional working gas 7 flowing in a flow direction F₃ of the additional working gas 7 can be blown in, which has been mixed with a powdery material 11 to be applied.

Since the electrode 6 can also be flushed from the outside with a working gas 3 flowing in a flow direction F₂ of the working gas 3, for example with argon, it may be advantageous for some applications to use the same gas in order to maintain a homogeneous gas mixture around the electrode 6 so that a homogeneous plasma will also remain in the arc 8. However, special applications can benefit from separate gas flows, for example, in order to form free carbon from CO₂ and H₂, which could be introduced into liquid metal for hardening.

A different way of introducing material is to allow a powdery material 11 to trickle through the channel 9, this type of introduction being referred to as gravitational conveyance. For this purpose, the powder is preferably conveyed under a controlled atmosphere in order to prevent contaminants or air from being supplied to the arc.

Another way of introducing material 11 is to push a material in the form of a wire or rod through the channel 9. If a conductive wire is used, the channel 9 is preferably insulated from the wire in order to prevent current from flowing through the wire. For this purpose, the channel 9 can be vaporized with ceramics on the inside, or a thin ceramic tube can be inserted into the channel 9. It should be noted that the electrode 6 conducts heat and the ceramic insert must therefore be similarly heat-resistant as the electrode 6. The arc power is usually set in such a way that the wire already melts at the level of the electrode opening, but preferably at the latest between the electrode and the nozzle.

The width of the welding track that has been applied depends on the width of the channel 9 in the electrode 6. The narrower the channel 9 at the base of the arc, the more narrowly can a powdery or wire-shaped material 11 be applied. The powder grain size can be chosen such that the diameter of the powder grains does not exceed half the diameter of the channel 9 in the electrode 6.

In order to control the position of the arc 8 and prevent it from migrating, the device comprises a nozzle 2 surrounding the electrode 6 as well as a working gas area formed between the electrode 6 and the nozzle 2. A working gas 3 with a high gas flow at the end of the electrode 6 can be pressed through the base of the arc 8, through the nozzle 2 or, respectively, the working gas area in order to form the arc 8. This is called a constricted arc, and the associated method is referred to as plasma welding. The electrode 6 can be placed axially behind the opening of a nozzle 2, i.e., on the side of the nozzle facing away from the workpiece.

Higher arc temperatures are possible with plasma welding by minimizing the thermal output at the electrode 6 and instead releasing it in the course of the arc 8. Furthermore, by constricting the arc 8, it becomes possible to stabilize the course of the arc 8. While a free arc always exhibits some random movement across the workpiece 10, the stationary arc can be secured by the gas stream, allowing for greater precision. In this case, the nozzle 2 has a larger diameter than the electrode 6. In order to keep the powder flow centered, the gas pressure of the stream through the electrode 6 can be adjusted to the gas pressure of the arc-forming gas stream.

The method can be carried out in a chamber filled with a further working gas 5, or the device 1 can have a further working gas area, with the further working gas 5 flowing in a flow direction F₁ of the further working gas 5 so that, in both cases, a controlled atmosphere is generated at an application point 12 of the workpiece 10. The further working gas area can be formed between the nozzle 2 and an atmosphere protection casing 4 surrounding the nozzle 2.

Material to be applied is supplied to the arc 8 through the channel 9 through the electrode 6 in the form of a powder or as a wire. Basically any material that does not denature at the temperatures in the arc 8 can be processed. However, for materials evaporating at the temperatures in the arc 8, the sudden increase in volume as the powdery or wire-shaped material 11 evaporates may cause turbulences, and the gas flow can be deflected, which contributes to the accumulation of powder residue on the electrode 6 or on the nozzle 2. The method is therefore suitable for materials that actually melt in the plasma but do not evaporate. For example, steel powder is suitable for joint welding, but the processing of ceramics and carbides in powder form for surface finishing is also possible.

The temperature of the arc 8 can be controlled by the arc power. Furthermore, with a controlled atmosphere, the gas composition can be chosen such that the voltage drop in the arc 8 corresponds better to the desired outputs. This voltage drop can be derived from the minimum of Paschen's law.

Higher outputs enable a higher material flow, with higher electrical currents expanding the arc 8, since the current density in the plasma remains constant. In order to maintain precision at higher outputs, it is necessary to choose a suitable gas which has a higher voltage drop, for example nitrogen or hydrogen instead of argon.

The method is applied by moving the active electrode 6 with a constricted arc 8 across the workpiece 10, while a powdery or wire-shaped material 11 is being supplied axially. In this case, especially the speed of movement of the electrode 6 across the workpiece 10 must be taken into account in particular in order to make sure that the material is applied in an optimal fashion.

If the speed of movement chosen is too low, material can be piled up on the workpiece 10 until it reaches the electrode 6 and leads to a defect, for example to a short circuit in case of a conductive material. On the other hand, if the speed of movement chosen is too high, hardly any powdery or wire-shaped material 11 can still be deposited and the thickness of a layer 13 of a layer 13 of a material 11 that has been supplied in a powdery or wire-shaped form, which layer has been applied over the workpiece 10, becomes inhomogeneous. In this case, the optimum speed of movement furthermore depends on the conveyed quantity of the powdery or wire-shaped material 11.

If an insulating material is to be applied, the arc 8 can be maintained by an alternating current source adapted to the capacity in order to apply several layers 13 on top of each other, provided that the layer 13 is homogeneous and the capacity of this layer 13 is known. Hence, the more layers 13 are applied on top of each other, the smaller becomes the capacity, which is why even higher frequencies of the alternating current source are necessary.

If, on the other hand, a conductive material, i.e., metal or conductive ceramics, is applied, several layers 13 can be placed on top of each other without using an alternating current source adapted to the capacity. Since the method enables a comparatively high precision, structures can thus be produced additively. In this additive manufacturing process, material is gradually added at selected locations to form a three-dimensional structure.

If several layers 13 are placed on top of each other, the current of the arc 8 is conducted through all layers 13. This heat load must be taken into account when designing a structure to be manufactured. In addition, the width of the arc 8 is determined by the current and must also be minimized for greater precision. Higher thermal outputs with a lower current can again be achieved by appropriately choosing the plasma gas, for example, nitrogen allows a voltage drop of approximately 100 V in contrast to argon, which causes a voltage drop of approximately 10 V at the arc 8. Since the connection between an output P, a voltage U and a current flow I is defined by P=U*I, the same output P can be achieved at a lower current flow I with a higher drop in voltage U.

Higher outputs and larger currents can be used for surface finishing. Electrodes 6 with wider diameters can also be used to allow more material transport. In order to apply materials with a high melting point, such as, for example, refractory metals, the dwell time in the arc 8 can be increased, which can be achieved by increasing the distance between the electrode 6 and the workpiece 10, thereby lengthening the arc 8.

In addition, active cooling can be applied so that the device 1 for welding can withstand the power losses of the arc 8 even better. Since the nozzle 2 can generally withstand lower temperatures than the electrode 6, the nozzle 2 can be provided with internal channels for cooling fluid. The electrode 6 can be cooled by contact cooling of the electrode holder. The latter is preferably made of conductive metal, which is also well suited for heat transport.

Furthermore, the speed of the resulting liquid droplets is relevant for surface finishing. The speed of the droplets can be regulated by the flow speed of the working gases 3, 7. In this connection, it should be noted that the gas increases its speed and provides additional acceleration due to the rapid heating in the arc 8.

If the material to be applied is supplied in the form of a rod or a wire or is conveyed gravitationally as a powder, the additional working gas 7 only has to be conveyed minimally in order to protect the material from contaminants and air as it is being fed into the arc. However, a gas flow with a high flow speed can also be used to transport powder with the additional working gas 7, which increases the impact velocity of the droplets.

If the gas exits the electrode 6 at the speed of sound or at supersonic speed, it should be noted that expansion shock waves may occur at the edge of the electrode 6, which can entrain powdery or wire-shaped material 11, thus, one the one hand, distributing it further and, on the other hand, tearing it out from the arc 8. This behaviour should be avoided if high precision is required. To avoid expansion shock waves, the ambient pressure and the flow speed of the surrounding working gas or, in a chamber with a controlled atmosphere, the chamber pressure can be adjusted so that a Prandtl-Meyer angle for the flow conditions is 0. This can be achieved directly at the arc 8 by a suitable shape of the electrode 6, for example a tip in the form of an aerospike nozzle.

In practice, a particularly precise build-up welding could be achieved in that the distance between the electrode 6 and the workpiece 10 was not more than 1.5 mm. A maximum conveying flow of 1000 SCCM has proved to be the preferred conveying flow of the powder-transporting additional working gas 7. Another result was that a particularly precise welding process was enabled by limiting the arc current to a maximum of 20 A.

1.-13. (canceled)

14. A method of build-up welding a powdery or wire-shaped material onto a workpiece, which is preferably a flat substrate, by means of a device which comprises an substantially rod-shaped electrode, the electrode having at least one material feed channel extending in its interior for feeding the powdery or wire-shaped material into the arc, characterized in that
the device comprises a nozzle surrounding the electrode and a working gas area which is formed between the electrode and the nozzle, the method comprising the following steps:
forming the arc as a transferred arc between the electrode and the workpiece or as a free-standing arc between the electrode and the nozzle,
flooding the working gas area with a working gas to constrict the arc in the direction of the workpiece,
feeding the powdery or wire-shaped material into the constricted arc and
moving the device across the workpiece as the powdery or wire-shaped material is being fed into the constricted arc.

15. A method according to claim 14, characterized in that a radial distance between the nozzle and the electrode is not larger than 1 cm and/or an axial distance between the end of the nozzle facing the workpiece and the end of the electrode facing the workpiece is not larger than 1 cm, with the end of the nozzle facing the workpiece preferably having a smaller distance from the workpiece than the end of the electrode facing the workpiece.

16. A method according to claim 14, characterized in that, between the nozzle and an atmosphere protection casing surrounding the nozzle, a further working gas area is formed which is flooded with another working gas so that a controlled atmosphere is generated at an application point of the workpiece, or that the device is used in a chamber with a controlled atmosphere.

17. A method according to claim 14, characterized in that the method is used for joint welding and the powdery or wire-shaped material for this purpose is preferably a metal, or the method is used for surface finishing and the powdery or wire-shaped material for this purpose preferably comprises ceramics, metal or carbide.

18. A method according to claim 14, characterized in that the powdery or wire-shaped material is supplied in an additional working gas, which is preferably argon, helium, carbon dioxide or nitrogen, wherein also the working gas and/or the further working gas is/are preferably argon, helium, carbon dioxide or nitrogen.

19. A method according to claim 14, characterized in that the distance between the electrode and the workpiece and/or a position of the electrode above the workpiece is controlled by a mechanical guide.

20. A method according to claim 14, characterized in that the powdery or wire-shaped material is applied to the workpiece in layers in order to form layers of material overlying each other.

21. A method according to claim 14, characterized in that the nozzle has internal channels for receiving cooling fluid, and/or the electrode has cooling means on its holder.

22. A method according to claim 14, characterized in that the opening diameter of the electrode is 1 cm at most, preferably essentially 300 μm at most, and the electrode is preferably tapered at its end facing the workpiece.

23. A method according to claim 14, characterized in that the arc power and the mixing ratios and/or the flow speeds of the gases as mentioned are adjusted in order to adjust the precision and the speed of the application of the powdery or wire-shaped material to the workpiece.

24. A method according to claim 14, characterized in that the powdery or wire-shaped material melts off in said arc.

25. A method according to claim 14, characterized in that the electrode ends in the feed direction of the powdery or wire-shaped material in front of the material feed channel or at the same point as the material feed channel.

26. A method according to claim 14, characterized in that the workpiece is arranged above the device during build-up welding.
